(19) United States
(12) Patent Application Publication
(10) Pub. No.: US 2017/0210610 A1
(43) Pub. Date: Jul. 27, 2017

(54) BEVERAGE DISPENSING APPARATUS FOR MEASURING FLOW AND REDUCING FOAMING IN DISPENSING SYSTEMS

(71) Applicants: Zachary William Henson, Menifee, CA (US); Ryan Patrick Sauter, Los Angeles, CA (US); Daniel Steven Martinez, Oceanside, CA (US)

(72) Inventors: Zachary William Henson, Menifee, CA (US); Ryan Patrick Sauter, Los Angeles, CA (US); Daniel Steven Martinez, Oceanside, CA (US)

(21) Appl. No.: 15/413,264

(22) Filed: Jan. 23, 2017

Related U.S. Application Data
(60) Provisional application No. 62/286,293, filed on Jan. 22, 2016.

(51) Int. Cl. B67D 1/08; B67D 1/14; B67D 1/12; B67D 1/00; B67D 1/04

(52) U.S. Cl. CPC B67D 1/0877; B67D 1/0004; B67D 1/0406; B67D 1/0855; B67D 1/0881; B67D 1/0888; B67D 1/1277; B67D 1/1272; B67D 1/1477

(57) ABSTRACT

Provided is a ready-to-install apparatus for dispensing carbonated beverages and/or beverages on draught that incorporates a flow sensor and a pinch valve and may be coupled to the end of a beer line (or any other tubing used for beverage dispensing) without having to be integrated within the line (i.e. eliminating the need to make multiple cuts for the valve, the flow sensor, etc.) The beverage dispensing apparatus reduces foaming by reducing the number of components that come into contact with the fluid and/or interfere with flow. For example, the beverage dispensing apparatus may utilize an external flow sensor to reduce the creation of nucleation sites where CO₂ bubbles may form. In another example, a pinch valve may be used to prevent excessive foaming in place of conventional valves that must be placed proximal to the keg.

### CLAIM OF PRIORITY

This application claims priority to U.S. Provisional Patent Application Ser. No. 62/286,293, filed Jan. 22, 2016, the entire disclosure of which is hereby expressly incorporated by reference herein.

### FIELD OF TECHNOLOGY

This disclosure relates generally to beverage dispensing systems and, more particularly, to an apparatus and system that couples to the end of a conventional beer line and reduces foaming while measuring flow volume in beverage dispensing systems.

### BACKGROUND

To determine a flow of beverage in contemporary draught systems, in-line flow meters are typically used. Examples of in-line flow meters include positive displacement meters and turbine meters. Turbine flow meters typically consist of a rotor that generates an electrical signal as fluid flows past the rotor and causes the rotor to spin. However, in-line flow meters can exacerbate beverage foaming by agitating the fluid and increasing nucleation sites available for bubbles to form. Specifically, spinning rotors in turbine flow meters agitate the carbonated beverage, allowing CO₂ bubbles to form and foam to accumulate. An in-line flow sensor is optimally positioned upstream of a valve, where the fluid is under the most pressure. If the flow sensor is placed downstream of the valve, the measuring integrity of the flow sensor would ail consistently due to intermittent pressure failure.

Overfoaming is also caused by the widespread use of conventional valves in current systems. Conventional valves contain numerous components, all of which must be NSF certified since they come in direct contact the beverage. Due to the mechanism of such valves, flow can be restricted in or between chambers of the valve. In these regions, the diameter of flow can be too restrictive and may result in foam creation if the valve is positioned close to the tap keg.

In order to diminish the effect of valves on foaming, valves are typically installed far from the tap (closer to the keg), allowing bubbles to dissipate before reaching the tap. Installing a conventional solenoid valve-based tap system usually requires cutting the tubing at specific locations along the line and inserting the tubing into the orifices of the valve. For commercial draught systems, this installation process usually requires a trained technician. Establishment owners that perform the own installation run the risk of wasting inventory (e.g., due to flat beer, extra foaming, and having to repeat the installation process). Thus, installation of such systems is costly and error-prone.

Thus, there exists a need for a dispensing solution that provides reliable flow metering when dispensing beverages, properly manages foam levels for carbonated beverages, and can be produced and installed at a low cost by commercial enterprises and residential end-users alike.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a depiction of current beverage dispensing systems showing a cross section of a refrigerated keg cabinet in which a valve and an in-line flow meter are installed close to a keg.

FIG. 2 is a cross section of a refrigerated keg cabinet comprising a beverage dispensing apparatus, according to one or more embodiments.

FIG. 3 is a block diagram showing components of the beverage dispensing apparatus of FIG. 2, according to one or more embodiments.

FIG. 4 is an exploded view of the beverage dispensing apparatus of FIG. 2 showing internal component detail, according to one or more embodiments.

FIG. 5 is a block diagram of a plurality of network-enabled beverage dispensing apparatuses communicating to a server through a network, according to one or more embodiments.

FIG. 6 is an embodiment of the beverage dispensing apparatus of FIG. 4 comprising a rotary tap mechanism in place of a valve, according to one or more embodiments.

FIG. 7 is an embodiment of the beverage dispensing apparatus of FIG. 4 providing means for a smartphone to be used as the flow sensor, according to one or more embodiments.

Other features of the present embodiments will be apparent from the accompanying drawings and from the detailed description that follows.

### SUMMARY

In one aspect, a beverage dispensing apparatus comprises a faucet coupled to an enclosure. The apparatus also comprises a flow sensor. The flow sensor may be positioned within the enclosure such that the flow sensor detects a velocity of a fluid flowing through the beverage dispensing apparatus. The apparatus also comprises a valve configured to enable regulation of the flow of the fluid.

### DETAILED DESCRIPTION

The disclosed embodiments provide a ready-to-install apparatus for dispensing carbonated beverages and/or beverages on draught that incorporates a flow sensor and a pinch valve and may be coupled to the end of a beer line (or any other tubing used for beverage dispensing) without having to be integrated within the line (i.e. eliminating the need to make multiple cuts for the valve, the flow sensor, etc.) The beverage dispensing apparatus reduces foaming by reducing the number of components that come into contact with the fluid and/or interfere with flow. For example, the beverage dispensing apparatus may utilize an external flow sensor to reduce the creation of nucleation sites where CO₂ bubbles may form. In another example, a pinch valve may be used to prevent excessive foaming in place of conventional valves that must be placed proximal to the keg.

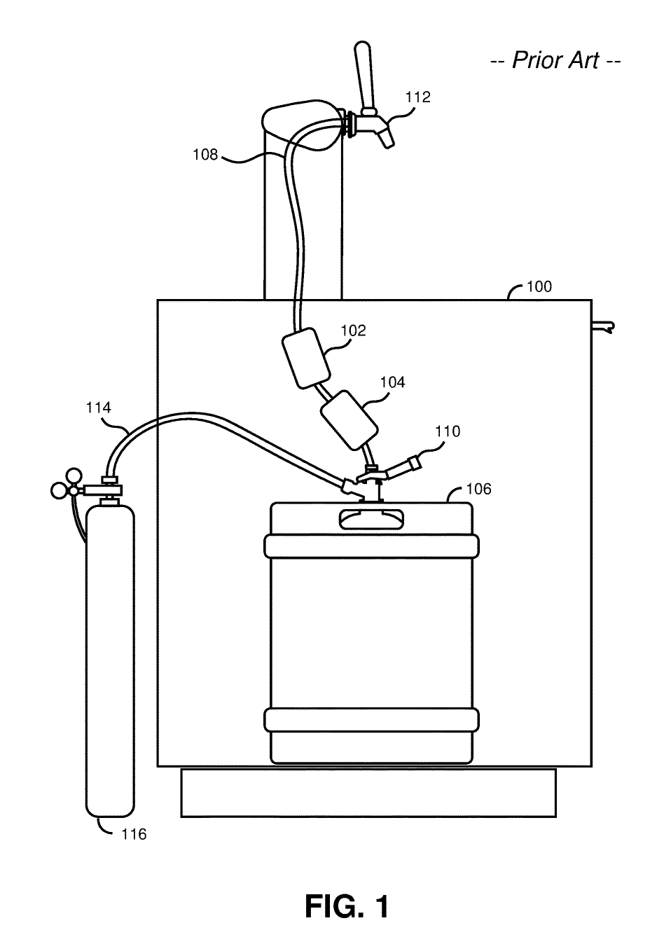

Reference is now made to FIG. 1, which is a depiction of current beverage dispensing systems showing a cross section of a refrigerated keg cabinet 100 in which a valve 102 and an in-line flow meter 104 are installed near a keg 106 to reduce foaming. The valve 102 is a normally closed (N/C) solenoid-activated valve or other valve used in the beverage dispensing industry. The in-line flow meter 104 may be any kind of in-line flow meter currently used in the beverage dispensing industry. For example, the in-line flow meter 104 may be a Swissflow® low pressure flow meter, it is assumed that a person having ordinary skill in the art (“PHOSITA”) understands the prevalence of solenoid valves and in-line flow meters in commercial and non-commercial beverage dispensing systems.

In order to facilitate in-line flow metering and prevent foaming, current beer dispensing systems require cutting a beer line 108 close to the keg 106 and placing the cut ends of the beer line 108 into the input and output orifices of the valve 102 and the input and output orifices of the in-line flow meter 104 such that the valve 102 and the in-line flow meter 104 are placed in series, with the valve 102 downstream of the in-line flow meter 104. When activated, a tap coupler 110 may be operated to allow a beverage from the keg 106 to flow through the beer line 108 and may charge the fluid passing through the tap coupler 110 with CO₂ gas from a CO₂ canister 116 fed through a CO₂ line 114.

Placing the valve 102 and the in-line flow meter 104 close to the keg 106 (e.g. within inches of the keg 106 in some installations) is key to providing enough length for foam in the beer line 108 that was created by the valve 102 and/or the in-line flow meter 104 to dissipate properly by the time the fluid is dispensed through a tap 112.

Foaming may occur if a length of the beer line 108 is not properly calibrated with respect to the pressure of the keg 108. In general, a longer beer line 108 will result in a lower serving pressure at the tap 112, which will cause dispensed beer to taste flat due to a loss in carbonation. Balancing a beer dispensing system involves calculating the length of the beer line 108 based on the pressure of the keg 106, the resistance of the beer line 108, the elevation of the keg 106 in relation to the tap 112, and the desired serving pressure of beer at the tap 112. These relationships are expected to be understood by a PHOSITA. They are shown roughly below:

$$Line Length = \frac{( Keg Pressure - Serving Presure - ( \frac{Height}{2} ) )}{Resistance}$$

where resistance depends at least on the inner and outer diameters and the material of the beer line 108 (usually 3/16″ inner diameter and 7/16″ outer diameter). Resistance may be affected by the operation of or materials composing the components of the dispensing system, such as the valve 102, the in-line flow meter 104, the beer line 108, the tap coupler 110, and the tap 112. Other components used in beverage dispensing systems may also affect the resistance of the system. Loss of pressure due to changes in elevation may be related to a specific gravity of the type of beverage being dispensed (e.g. ales, lagers, stouts, etc.). Though this relationship is not reflected in the equation above, it is still contemplated in the embodiments described herein.

The in-line flow meter 104 and the valve 102 agitate flowing carbonated beverages and cause CO₂ bubbles to be formed. For this reason, the in-line flow meter 104 and the valve 102 are best placed far enough from the tap 112 so as to provide enough length in the beer line 108 for CO₂ bubbles to dissipate, either completely or in part (if a certain amount of foaming is desired).

An issue with current dispensing systems is having to place the in-line flow sensor 104 upstream of the valve 102 and having to place both components far from the dispensing end of the system.

The measuring integrity of the in-line flow sensor 104 depends on maintaining the pressure of the fluid passing through the in-line flow sensor 104 (i.e. the upstream fluid). Since the fluid pressure is highest upstream of the valve 102, optimal placement of the in-line flow sensor 104 is upstream of the valve 102. Fluid pressure may vary downstream of the valve 102 during normal operation of the valve 102. Fluid pressure may also vary across the valve 102 and across the in-line flow sensor 104. Thus, distortions in the measurement of the in-line flow sensor 104 may be minimized by placing the in-line flow sensor 104 upstream of the valve.

However, the in-line flow meter's 104 optimal position in relation to the valve 102 may depend on a number of factors, such as the condition of the fluid, the type of fluid, operating parameters of in-line flow meter 104 and other components, degree of pressure drop across the valve 102 and across the in-line flow meter 104, the presence and amount of straight run in the beer line 108 before and after the valve 102 and the in-line flow meter 104, and other factors.

As shown, the various components (valve 102, in-line flow sensor 104, tap 112) of the refrigerated keg cabinet 100 are scattered throughout the refrigerated keg cabinet 100. In order to install these various components, each component must be treated individually, by cutting 1) the beer line 108 an appropriate length, 2) making the necessary cut for the valve 102, and 3) making the necessary cut for the in-line flow sensor 104. This repetitive work is error-prone, and installing such dispensing systems may cause leaks due to errors during cutting the beer line, inaccurate calibration of the in-line flow meter 104, non-optimal placement of the components in relation to each other and in relation to the tap 112, errors in calculating serving pressure with respect to beer line length, and other risks. The potential for such risks is usually more than enough to convince an end-user to hire a trained expert to install the system and maintain it regularly.

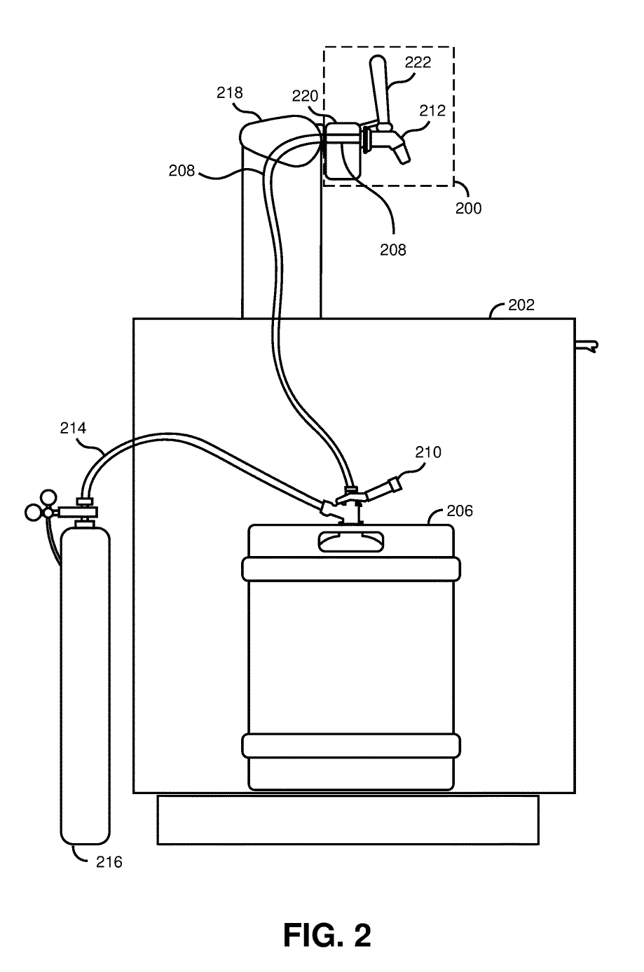

Reference is now made to FIG. 2, which is a cross section of a refrigerated keg cabinet 202 comprising a beverage dispensing apparatus 200, according to one or more embodiments. The refrigerated keg cabinet 202 additionally comprises a keg 206 to which a tap coupler 210 is coupled. When properly tapped, the keg 206 dispenses fluid through a tubing 208 and carbonates the fluid through tubing 214 from a CO₂ canister. The tubing 208 extends through a dispensing tower 218 to the beverage dispensing apparatus 200.

Installation of the beverage dispensing apparatus 200 involves measuring the length of tubing 208 needed to achieve a proper serving pressure, making an appropriate cut to shorten the tubing 208 to that length if needed, and coupling the end of the tubing 208 distal to the keg to the beverage dispensing apparatus 200. Thus, the beverage dispensing apparatus 200 is an all-in-one solution that makes installation of a valve, flow sensor, and a tap 212 in beverage dispensing systems a seamless task.

The beverage dispensing apparatus 200 may also incorporate one or more electronic components allow control of the valve and the flow sensor, and also to communicate flow sensor data and other data with other devices through a network interface. Once initialised, the beverage dispensing apparatus 200 may be configured to communicate through a wired or wireless network connection with another data processing device directly or through a network. The network connection may, for example, be used to calibrate the beverage dispensing apparatus 200 which may involve adjusting the sensitivity of the flow sensor.

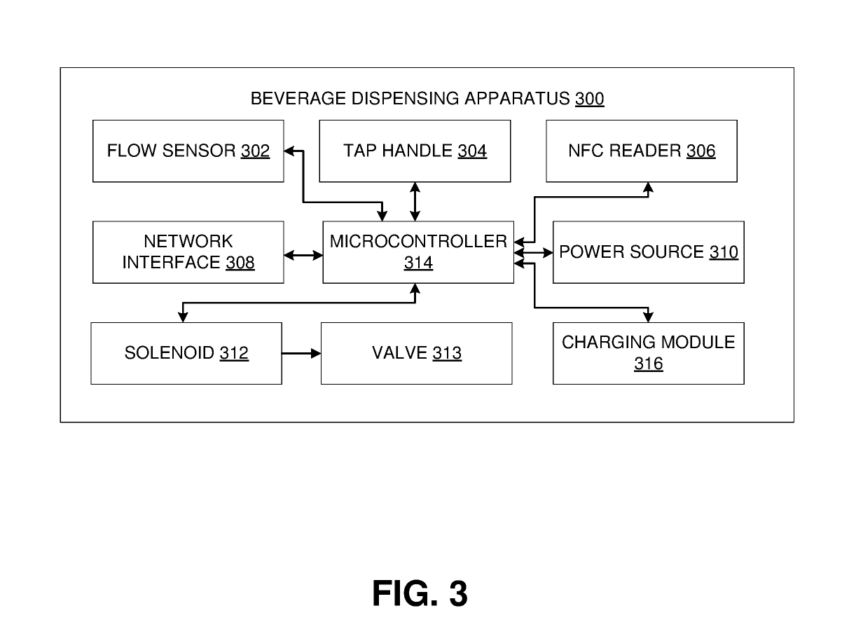

Reference is now made to FIG. 3, which is a block diagram showing components of the beverage dispensing apparatus of FIG. 2, according to one or more embodiments. In one or more embodiments, a beverage dispensing apparatus 300 comprises a flow sensor 302, a tap handle 304, a near-field communication (NFC) reader 306, a network interface 308, a power source 310, a solenoid 312, a valve 313, a microcontroller 314, and a charging module 316.

In one embodiment, the flow sensor 302 may be an in-line flow meter or an external flow meter and may use any means known in the art for deter determining volume flow of a fluid. For example, the flow sensor 302 may be a turbine flow meter, an accelerometer-based sensor, a barometric (pressure) flow sensor, an electromagnetic flow sensor, an acoustical or ultrasonic metering module, or any other type of flow sensor. However, in a preferred embodiment, the flow sensor 302 is an external flow sensor to prevent contact with the fluid dispensed through the beverage dispensing apparatus 300 and thus reduce foaming.

In the above-mentioned preferred embodiment, the flow sensor 302 may operate externally to the tubing 208 (i.e. without requiring components to be inserted into the tubing). In this case, the flow sensor 302 may be located downstream or upstream of the valve 313 since the flow sensor's has little to no effect on the foaming of the fluid. If the flow sensor 302 were an in-line flow sensor, optimal placement would be upstream of the valve 313.

Installing an external flow sensor does not require cutting the tubing 208, a process that is a common practice when installing in-line flow meters and valves. For most end-users, installing a flow sensor in a current system is an error-prone process and requires careful execution due to extra cutting and complex tubing length calculations. As such, homebrew owners and small businesses wishing to install a high-quality dispensing system that measures the flow rate of dispensed beverage are forced to use special equipment and/or pay for expert installations and maintenance costs.

Cutting tubing requires certain steps to be carefully executed, such as measuring the exact length of the tubing based on the change in pressure across the flow meter and the valve, regularly testing the system for leaks (e.g. using soapy water) and adjusting CO₂ or nitrogen pressure to account for the foaming generated by any of the components of the beverage dispensing apparatus 300 or the tubing 208. As such, installation of in-line flow meters, valves, and most draught dispensing systems is usually performed by a trained specialist.

The barrier to entry is lower for a dispensing system using an external flow sensor due to reduced certification costs. Any internal component that comes into contact with consumed beverages must be NSF certified, which causes manufacturing costs to increase. To meet certification standards, manufacturers may need to use expensive materials, pay certification fees, or incur other costs. Thus the beverage dispensing apparatus 202 may avoid some certification requirements by locating all components in the housing 220, especially the flow sensor 302 and the valve 313 out of direct contact with the beverage.

In one embodiment, the tap handle 304 may be any tap handle commonly installed in current dispensing systems (e.g. tap handles that are provided by beer manufacturers). In another embodiment, the tap handle 304 may be replaceable, e.g. by any tap handle provided by a beer manufacturer or an after-market tap handle. In yet another embodiment, the tap handle 304 may incorporate electrical components such as an NFC extender configured to extend the range of an antenna of the NFC reader 306. In another embodiment, the tap handle 304 may incorporate a display screen communicatively coupled to the microcontroller 314, which display screen may be used to display advertisements, information about the beverage dispensable through the beverage dispensing apparatus 300, information about the user operating the beverage dispensing apparatus 300, calibration information for any of the components of the beverage dispensing apparatus 300, and more.

In another embodiment, the beverage dispensing apparatus 300 and/or the tap handle 304 may incorporate an accelerometer, which may be communicatively coupled to the microcontroller 314. Readings from the accelerometer may supplement data from the flow sensor 302 to provide a more comprehensive and accurate analysis of the volume of beverage dispensed through the beverage dispensing apparatus 300, assuming the accelerometer is properly calibrated. For example, the tap handle 304, tilted at a certain angle, may cause the beverage dispensing apparatus 300 to dispense a beverage at a known flow rate based on the forces measured by the accelerometer and the calibration settings of the accelerometer. In case the flow sensor 302 provides inconsistent or faulty data for any reason, the accelerometer data may be utilized to generate another layer of redundant flow data, and vice versa.

The title of the tap handle 304 may cause the solenoid 312 to activate or deactivate, subsequently causing the valve 313 to regulate flow of the fluid through the beverage dispensing apparatus 300. In one embodiment, the tap handle 304 has no mechanical function beyond tilting. In concert with an accelerometer, the tap handle 304 may be tilted to generate accelerometer readings, which readings may be compared to threshold values through the process of the microcontroller 314 to issue control signals to any of the components of the beverage dispensing apparatus 300. For example, when the tap handle 304 is tilted, the change in accelerometer reading (i.e. the forces acting on the tap handle 304) may be detected, and may trigger a control signal to be issued to the solenoid 312 to activate the solenoid 312 and release the valve 313, thus causing the fluid to flow through a faucet or spigot of the beverage dispensing apparatus. ‘Faucet’ or ‘spigot’ may refer to any dispensing end through which a fluid may flow and does not necessarily imply an integrated means of controlling the flow of such fluid.

The NFC reader 306 may be configured to read information stored in an NFC tag to operate the solenoid 312, configure the network interface 308 settings, and communicate control signals and configuration parameters to any other components of the beverage dispensing apparatus 300. The NFC tag may be incorporated in an NFC bracelet, an NFC ring, a smartphone, a device (wearable or not), or garment that can be configured to interact with the NFC reader 306. The NFC reader 306 may be configured to read data encoded in the NFC tag or establish a pairing connection with an NFC-enabled device by obtaining the proper credentials via NFC. Others wireless connections and their respective ranges (such as Bluetooth®, BLE, WiFi, and all types of RFID) are within the scope of the exemplary embodiments described herein.

NFC may operate other modes, such as a peer-to-peer mode and a card emulation mode. The NFC reader 306 may initiate a peer-to-peer mode connection with another device (e.g. a smartphone) to facilitate bi-directional communication and data exchange enabled by an NFC reader in the other device, in one embodiment, the peer-to-peer mode may facilitate communication of data from the NFC reader 306 to the NFC reader of the other device and vice versa. Applied to the beverage dispensing apparatus 300, bi-directional communication between a smartphone (or other mobile device) and the beverage dispensing apparatus 300 may enable any of the group consisting of: querying real-time parameters and data from the flow sensor 302, calibration of the flow sensor 302, configuration of the network interface 308, control of the solenoid 312, querying the, power level of the power source 310 (especially if the power source 310 is a battery). Any of the components of the beverage dispensing apparatus 300 may be controlled via peer-to-peer mode and/or the data provided thereby may be queried and received via peer-to-peer mode.

Peer-to-peer mode may also enable a user to perform any number of calibration steps with any components incorporated into the beverage dispensing apparatus 300. For example, upon installation of the beverage dispensing apparatus 300, a user may wish to calibrate the beverage dispensing apparatus 300 and adjust the sensitivity of the flow sensor 302. Additionally, the user may wish to check for sufficient power from the power source 310 or query the charging status of the charging module 316. The user may also wish to enable the network interface 308 or modify the configuration thereof.

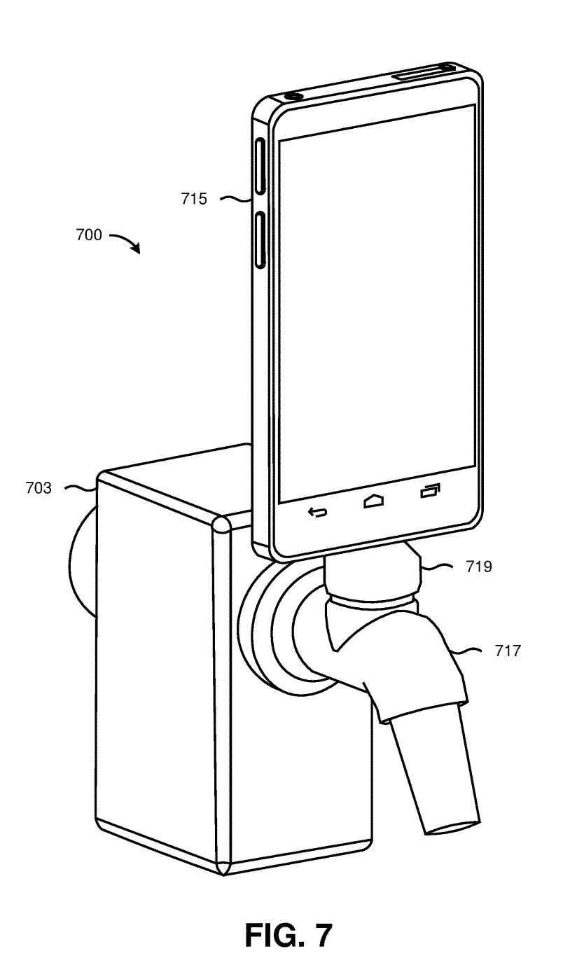

In another embodiment, the NFC reader 306 may be incorporated into the tap handle 304. The tap handle 304 may also be outfitted with a locking mechanism and may be unlocked upon recognition of an NFC tag or NFC-enabled device with the proper authorization. In yet another embodiment, the tap handle 304 may incorporate a mounting dock for an NFC-enabled mobile device, e.g. a smartphone. When the smartphone is placed in the mounting dock, an NFC connection may be initiated between the smartphone and the NFC reader 306 in read/write mode or peer-to-peer mode. For a more detailed discussion, please see FIG. 7.

The solenoid 312 and the valve 313 may be configured to dispense carbonated beverages. In one embodiment, the valve 313 may be a latch valve or a pinch valve. A latch valve or a pinch valve may operate by squeezing the beer line 208 to prevent the flow of the beverage. A latch valve is advantageous because its parts do not come into contact with the beverage and therefore, less nucleation sites are provided for foam production.

Also, the shape of the cross section of the beer line 208 as it is acted upon by the valve 313 also causes less foam production. The shape of the cross section of the beer line 208 when the solenoid 312 is not activated is a circle. When the solenoid 312 is activated and the valve 313 acts upon the beer line 208, the circle gradually changes into an ellipsis and eventually flattens. Throughout the transition, few if any edges provide limited opportunity for spontaneous CO₂ bubbles to form. Thus, a latch valve or a pinch valve may be preferred in order to prevent sudden changes in flow diameter throughout the valve. In current systems, conventional valves with mechanical components that contact the fluid cause sudden changes to the diameter of flow and thus cause the pressure of the fluid to change rapidly in a small space, thus further agitating charged fluids such as carbonated beer and causing overfoaming in the fluid leaving the valve. For this reason, conventional valves must be placed far from the dispensing end, but a latch valve or a pinch valve may be positioned close to the dispensing end. Combined with a flow sensor configured to reduce foaming (e.g. an external flow sensor, an in-line flow sensor upstream of the valve 313), the beverage dispensing apparatus minimizes contact between its components and the fluid and provides a seamless solution to current systems.

The microcontroller 314 may comprise a processor configured to execute instructions stored in a memory of the microcontroller 314. When executed, the instructions may cause the beverage dispensing apparatus 300 to perform a variety of different functions. In one embodiment, instructions stored in the memory of the microcontroller 314 may be executed to detect a signal received by the NFC reader 306. The signal may comprise data associated with a user intending to operate the beverage dispensing apparatus 300. Such data may include identification (e.g. name, photo, etc.), contact details (e.g. phone number, email address, social media username etc.), driver license details (e.g. birth date for determining legal age), payment details (e.g. credit card number, tab account number), a history of beverage amount dispensed, an amount f beverage to be dispensed, a calculated current blood alcohol content (BAC) level of the user based on the history of beverage amount dispensed, a maximum BAC for the user, other users associated with the user, the amount dispensed recently for the other users, identification/contact details of a designated driver for the user, types of beverages the user intends to consume, past advertisements viewed by the user, etc. Other data may be communicated through the NFC tag and are within the scope of the exemplary embodiments described herein.

In another embodiment, instructions stored in the memory of the microcontroller 314 may be executed to configure a network connection of the network interface 308, query parameters and/or data from the flow sensor 302, operate the solenoid 312, query or modify parameters of the power source 310, query or modify parameters of the charging module 316, and communicate with data processing devices communicatively coupled to the microcontroller 314 through a network, a connection to which is established through the network interface 308.

The network interface 308 may be any onboard or adapter-based circuit enables a connection between the microcontroller 314 and a wired or wireless network. In one embodiment, the network interface 308 may be an Ethernet adapter (e.g. using a RJ45, power-enabled connector), a Wi-Fi adapter, or a Bluetooth® adapter. Any number and type of network interfaces enabling any type of wireless and/or wired communication are within the scope of the embodiments described herein.

The power source 310 of the beverage dispensing apparatus 300 may provide power to any of the components of the beverage dispensing apparatus 300. In one embodiment, the power source 310 may comprise one or more batteries. The one or more batteries may be rechargeable. The one or more batteries may be alkaline, lithium ion, or any other type of chargeable or rechargeable battery. Alternately, the power source 310 may derive power through an Ethernet connection (e.g. through the network interface or other component).

The charging module 316 may be any circuit, electromechanical device, or adapter configured to provide a means for charging power source 310 (if the power source retains charge using a battery or a capacitor) providing power to any of the components of the beverage dispensing apparatus 300. For example, the charging module 316 may be a photovoltaic solar panel. In another example, the charging module 316 may be a stirling engine and may exploit temperature disparities to generate power. A stirling engine may be preferred since beverages passing through the beverage dispensing apparatus 300 may be of a lower temperature than the surroundings of the beverage dispensing apparatus 300 due to it originating from a refrigerated vessel. In another example, the charging module 316 may be configured to receive wireless power through Wi-Fi™ or any other wireless power source.

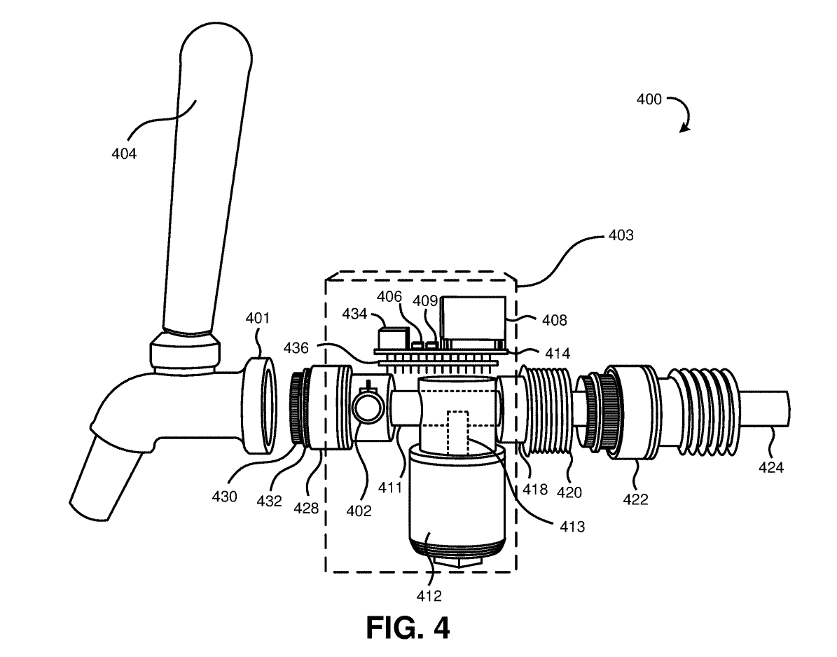

Reference is now made to FIG. 4, which is an exploded view of the beverage dispensing apparatus 300 of FIG. 3 showing internal component detail, according to one or more preferred embodiments. The beverage dispensing apparatus 400 may comprise a tap 401 and an enclosure 402. The enclosure 403 has been made transparent in FIG. 4 to show the internal components of the enclosure 403. The enclosure 403 may differ in overall size and shape and thus, the portrayal of the enclosure 403 in the Figures is intended to be illustrative rather than restrictive. Any number of components of the beverage dispensing apparatus 400 may be disposed within the enclosure 403. Any electrical, mechanical, and electromechanical components of the beverage dispensing apparatus 400 may be oriented differently, replaced with other components, or removed entirely, or additional components may be added. Thus, FIG. 4 is included as an illustrative embodiment and should not be construed as limiting.

As shown in FIG. 4, a milled shank 430 may nest within the tap 401. The milled shank 430 may be coupled to a shank sleeve 432 subsequently nested within a nut 428 comprising an aperture. A flow sensor 402 (e.g. an external flow sensor such as an electromagnetic flow meter or an ultrasonic flow meter) may be housed within the nut 428 and may gain access to a tube 411 extending through the enclosure 403 through which beverage may flow.

The tube 411 may be a segment of conventional beer line having a 3/16″ inner diameter and 7/16″ outer diameter or a tube having different physical parameters. Tubes with more flexible characteristics (similar diameters, smaller diameters) may be more suitable for use with a pinch valve or latch valve than a conventional beer line. Furthermore, a more flexible and/or thinner tube may not require as heavy duty a valve thus allowing a manufacturer to keep production costs low by providing a thinner tube and a pinch valve using. The tube 411 may be larger or may be a thinner, softer, and/or more flexible tube having a 3/16″ ID and a ⅜″ OD (difference of 3/16″ between diameters instead of ¼″ difference in conventional beer line) or similar diameters. In any case, the tube 411 may be a built-in tubing provided standard in the beverage dispensing apparatus 400 in order to ease the installation process. The tube 411 may be replaceable with tubes of different physical parameters (e.g. diameter, material)

Flow within the tube 411 may be controlled by a valve 413 operation by a solenoid 412 that may deploy a pinch valve 413 configured to restrict or allow flow within the tube 411. The tube 411 may extend further through a gasket 418. The gasket 418 may be coupled to a male screw thread 420. The tube 411 may extend to a beer shank 422, to which tubing 424 from the keg may be attached (e.g. conventional beer line).

Before installing the beverage dispensing apparatus 400, a user may calculate a length of tubing 424 that provides for optimal serving pressure, cut the tubing 424 once, and couple the end to the beer shank 422. As such, only a single cut may be necessary. In cases where the tubing length does not need to be changed, no cuts may be necessary. This feature allows the beverage dispensing apparatus 400 to be easily integrated into any draught system, refrigerated keg cabinet, or carbonated beverage dispensing system.

The enclosure 403 may also comprise a microcontroller 414. Onboard the microcontroller 414 may be one or more electrical components and/or one or more modules. In one embodiment, the microcontroller 414 may comprise a wired network interface 408 (e.g. an Ethernet port), a wireless network interface 409 (e.g. a Wi-Fi adapter, a Bluetooth® adapter, etc.), an NFC reader 406, and a USB port 434. The microcontroller 414 may comprise further modules and or electrical components necessary for operation of the beverage dispensing apparatus 400.

The microcontroller 414 may be communicatively coupled to any electrical component the beverage dispensing apparatus 400. For the purposes of this detailed description, all mentions of the phrase “communicatively coupled” should be interpreted to include any wireless or wired means of communication. In one embodiment, the microcontroller 414 may be an Arduino or a Raspberry Pi chip. The microcontroller 414 may also be communicatively coupled to the solenoid 412 (e.g. may activate/deactivate the valve 413). Furthermore, the microcontroller 414 may also be communicatively coupled to the flow sensor 402.

In one embodiment, a thermal shield 436 may be disposed within the enclosure 403 and specifically positioned between the microcontroller 414 and the tube 411 to prevent any heat dissipation from the one or more electrical components of the microcontroller 414 from affecting the temperature of fluid flowing through the tube 411.

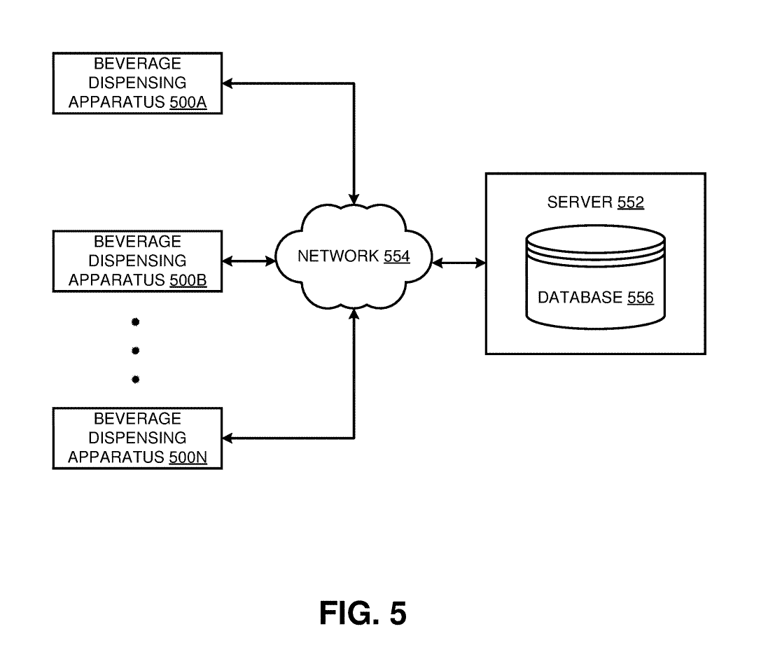

Reference is now made to FIG. 5, which is a block diagram of a plurality of network-enabled beverage dispensing apparatuses 500A-N communicatively coupled to a server 552 through a network 554, according to one or more embodiments. The server 552 may comprise a database 556 where the data communicated to the beverage dispensing apparatuses 500A-N (e.g. through the NFC reader 406 or the network interface 408) may be stored in addition to or in place of the memory of the microcontroller 414.

The server 552 may comprise one or more analytics libraries configured to parse the data stored in the database 556. For example, parsed data may be a volume of liquid poured by an individual (which may be used to estimate a blood alcohol content (BAC) or a glucose level of the individual). The data may be used in real-time with the type of beverage poured to display targeted advertisements (e.g. through a display screen of the tap handle 404) that invite the individual to purchase or consume a subsequent product. Repeated consumption of specific brands of beverage may be tracked and may aid in deploying targeted advertisements that offer an individual a discount on a product that he/she has been consuming often. In aggregate, the parsed data and any post-processing may be commoditized and sold to interested parties. Alternately, a manager of an establishment making use of the beverage dispensing apparatuses 500A-N may utilize the data to assess losses, improve sales/marketing, optimize product selection, reduce waste (from foaming), and more.

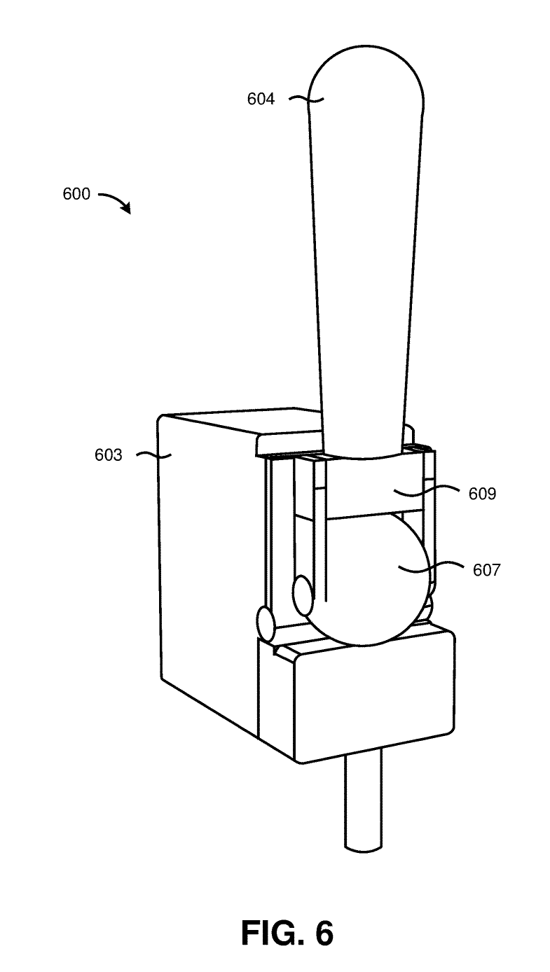

Reference is now made to FIG. 6, which is an embodiment of the beverage dispensing apparatus 400 of FIG. 4 comprising a rotary tap mechanism 607 in place of a valve, according to one or more embodiments. In one embodiment, a beverage dispensing apparatus 600 may comprise a rotary mechanism 607. The beverage dispensing apparatus 600 may also comprise an enclosure 603, a tap handle 604, and an accelerometer 609. The accelerometer 609 may aid in determining flow rate for beverages dispensed through the beverage dispensing apparatus 600 by measuring the vertical tilt of the tap handle 604, which readings may be used to calculate flow rate (provided that the beverage dispensing apparatus 600 is properly calibrated).

Reference is now made to FIG. 7, which is an embodiment of the beverage dispensing apparatus 400 of FIG. 4 providing a means for an NFC-enabled smartphone 715 to be used as the flow meter, according to one or more embodiments. In one embodiment, a beverage dispensing apparatus 700 may comprise a smartphone 715 (detachable, and may be used to operate the beverage dispensing apparatus 700 via WiFi, NFC or other network interface), an enclosure 703, a spout 717, and a mounting base 719. The mounting base 719 may provide a mounting location for the smartphone 715. The mounting base 719 may also be NFC-enabled in order to initiate an NFC connection between the beverage dispensing apparatus 700 and the smartphone 715.

One benefit of utilizing a smartphone 715 in place of a tap handle (such as the tap handle 304 of FIG. 3, the tap handle 404 of FIG. 4, or the tap handle 604 in FIG. 6) is to reduce the overall production cost of the beverage dispensing apparatus 700 by eliminating the need for a separate tap handle and a separate flow sensor in the beverage dispensing apparatus 700. Virtually all smartphones currently comprise an accelerometer and/or a gyroscope (typically a 6-axis gyroscope), which may be used to calculate a flow of beverage flowing through the spout 717 based on the vertical tilt of the smartphone 715. When properly calibrated, the beverage dispensing apparatus 700 may be a modular, highly-configurable, low-cost dispensing system ideal for large-scale deployment. Most smartphones are also NFC compatible, allowing NFC communication with beverage dispensing apparatus components. In addition, the display screen of the smartphone 715 may be utilized to display messages, advertisements, or information to the user operating the beverage dispensing apparatus 700.

For example, a self-serve bar may comprise a plurality of beverage dispensing apparatuses, e.g. the beverage dispensing apparatus 700. Each beverage dispensing apparatus 700 may feed data to a central server where data is stored. The stored data may be viewed and analyzed by an owner of the restaurant in order to determine ROI and aid in calculating financial projections crucial to the long-term success of the enterprise.

One key analysis may be to determine the amount of foamed beer based on a comparison between the amount of volume calculated through the beverage dispensing apparatuses and the total volume of kegs completed. This comparison may aid an administrator of the system to pinpoint specific beverage dispensing apparatuses that need calibration on a real-time basis. Reports may be generated, by the server or the particular beverage dispensing apparatus 700 in need of attention, to alert the administrator that the beverage dispensing apparatus 700 has experienced a fault. The system may automatically deactivate the solenoid of the faulty beverage dispensing apparatus in order to prevent waste of beverage and/or CO₂ (e.g. by foaming). Once properly notified, a technician of the system (or an employee of the establishment) may perform repairs and/or recalibrate the faulty beverage dispensing apparatus. Regular reporting may facilitate maintenance and improve overall performance and uptime of the entire system of beverage dispensing apparatuses.

Although the present embodiments have been described with reference to specific example embodiments, it will be evident that various modifications and changes may be made to these embodiments without departing from the broader spirit and scope of the various embodiments. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The various devices and modules described herein may he enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits application specific integrated (ASIC) circuitry and/or Digital Signal Processor (DSP) circuitry).

What is claimed is:

1. A beverage dispensing apparatus comprising:
a flow sensor positioned within the beverage dispensing apparatus such that the flow sensor detects a velocity of a fluid flowing through the beverage dispensing apparatus; and
a valve configured to enable regulation of the flow of the fluid.

2. The beverage dispensing apparatus of claim 1, further comprising:
a microcontroller having a processor and a memory, wherein the flow sensor is communicatively coupled to the microcontroller; and
a solenoid communicatively coupled to the microcontroller and operably coupled to the valve such that operation of the solenoid through the processor causes the valve to regulate the flow of the fluid.

3. The beverage dispensing apparatus of claim 2, further comprising a near-field communication (NFC) reader, wherein the NFC reader is configured to be activated by an NFC tag or an NFC-enabled device to operate the solenoid through the processor.

4. The beverage dispensing apparatus of claim 2, further comprising an NFC reader, wherein the NFC reader is configured to:
read user data from an NFC tag or an NFC-enabled device; and
operate the solenoid through the processor based on the user data.

5. The beverage dispensing apparatus of claim 2, wherein the memory comprises instructions that when executed by the processor, cause the device to:
receive, by the processor, a calibration signal; and
adjust, through the processor, one or more parameters of the solenoid or the flow sensor.

6. The beverage dispensing apparatus of claim 2, further comprising a handle operably coupled to the valve.

7. The beverage dispensing apparatus of claim 6, further comprising an accelerometer disposed within the handle and communicatively coupled to the processor, wherein the processor is configured to execute instructions stored in the memory to calculate a flow rate of the fluid based on the degree of vertical tilt of the handle measured by the accelerometer.

8. The beverage dispensing apparatus of claim 1, wherein the valve is a latch valve or a pinch valve.

9. The beverage dispensing apparatus of claim 1, wherein the flow sensor is an external flow sensor.

10. The beverage dispenser apparatus of claim 9, wherein the flow sensor is positioned downstream or upstream of the valve.

11. The beverage dispensing apparatus of claim 1, wherein the flow sensor is an in-line flow sensor.

12. The beverage dispenser apparatus of claim 11, wherein the in-line flow sensor is positioned upstream of the valve.

13. The beverage dispenser apparatus of claim 1, further comprising an interchangeable tube providing a path for the fluid to flow to a dispensing end of the beverage dispensing apparatus.

14. The beverage dispenser apparatus of claim 13, wherein the fluid flows through the interchangeable tube.

15. The beverage dispenser apparatus of claim 13, wherein the valve is configured to regulate the flow of the fluid by compressing the interchangeable tube upon operation of the solenoid.

16. The beverage dispenser apparatus of claim 13, wherein the flow sensor detects a velocity of the fluid flowing through the interchangeable tube.

17. The beverage dispenser apparatus of claim 2, further comprising a thermal shield positioned between the microcontroller and the flow path of the fluid.

18. The beverage dispenser apparatus of claim 6, wherein the tap handle comprises a display screen communicatively coupled to the microcontroller and configured to display one or more of the group consisting of: one or more advertisements, identification information of the fluid, identification information of a user operating the beverage dispensing apparatus, calibration information for any of the components of the beverage dispensing apparatus, payment details, a history of beverage amount dispensed, current blood alcohol content level of the user, maximum allowed BAC level of the user, identification information for a designated driver for the user, types of beverages the user can choose to consume.

19. The beverage dispensing apparatus of claim 4, wherein the user data comprises one or more of the group consisting of: name, photo, contact details, driver's license details, a history of beverage amount dispensed, an amount of beverage to be dispensed.

20. The beverage dispensing apparatus of claim 1, further comprising a power source configured to provide power to the various components of the beverage dispensing apparatus and charge through one or more of the group consisting of: a wired Ethernet connection, a wireless power source, a stirling engine, and a photovoltaic solar panel.

21. The beverage dispensing apparatus of claim 13, wherein the interchangeable tube is configured to allow coupling with a tubing from a beverage source.
